(19) United States
(12) Patent Application Publication
(10) Pub. No.: US 2008/0187566 A1
(43) Pub. Date: Aug. 7, 2008

(54) Sustained release delivery systems for turf, pasture, and home applications

(76) Inventors: Peter Van Voris, Daniel Island, SC (US); Dominic A. Cataldo, Kennewick, WA (US); Edward S. Lipinsky, Worthington, OH (US); Robert Kenneth VanderMeer, Newberry, FL (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 12/069,112

(22) Filed: Feb. 7, 2008

Related U.S. Application Data
(63) Continuation-in-part of application No. 10/325,327, filed on Dec. 20, 2002, now abandoned.

(51) Int. Cl. A01N 25/10; A01P 17/00

(52) U.S. Cl. 424/409

(57) ABSTRACT

A method to control on a sustained basis insect pests wherein the insect pests are exposed to repellent chemicals lodged in a high tortuosity microporous polymeric material.

### CROSS-REFERENCE TO RELATED APPLICATIONS

This application claims priority of provisional application Ser. No. 60/342,378, filed on Dec. 27, 2001, entitled, “Sustained Release Systems for Turf Applications”, and is a continuation-in-part of application Ser. No. 10/325,327, filed Dec. 20, 2002, the disclosures of which are expressly incorporated herein be reference.

### STATEMENT REGARDING FEDERALLY SPONSORED RESEARCH

The government has rights herein pursuant to Federal USDA SBIR Grant Phase I Award Number 2002-33610-11855 and Phase II Award Number A5293P1.

### BACKGROUND OF THE INVENTION

The present invention generally relates to pest management and more particularly to an improvement for a sustained release delivery method for controlling pests, particularly fire ants.

Current pest management methods and delivery systems for turf, pasture, and home have very serious drawbacks. A partial list of these deficiencies is provided below:
Both turf and home are not well protected from pests such as, for example, fire ants, mole crickets, cockroaches, spiders, silverfish and weeds.
   a. Treatments do not last long enough.
   b. Treatments are not comprehensive enough.
   c. Rains can wash away the applied chemicals outside the home.
   d. The pesticide can easily degrade because it is not protected after being applied.
Customers' needs are not met.
   a. Too many separate applications.
   b. Costs are too high because of repeat applications.
   c. Customer is exposed to chemicals that may have acute and/or long-term effects.
   d. Pets and neighbors risk the potentially of being exposed to chemicals.
The Pest Control Operator's (PCO) that apply the chemical to either the inside or outside of the home or to the turf or pastures needs are not met.
   a. Call backs and reapplications under warranty increase costs and reduce profits.
   b. PCO appliers can be at risk due to chemical exposure.
   c. Excessive truck transportation, warehousing, etc., raise costs.
   d. Liability problems affect image and raise costs.

This disclosure in particular is aimed at repelling fire ants from designated locales. The Red Imported Fire Ant (“RIFA”) and its related domestic species present problems related to health and safety and disruption to commerce. From a safety standpoint, the RIFA is a problem for homeowners, livestock, wildlife, industrial sites, and electrical components due to their presence and likelihood to both inflict severe bits and adversely affect electrical gear. Similarly, many areas have imposed quarantines on foodstuffs, agricultural commodities, and any material that could contain RIFA's, and, thus, act as a vector for transport of the RIFA across both state and international borders.

### BRIEF SUMMARY OF THE INVENTION

A method to control on a sustained basis insect pests wherein the insect pests are exposed to repellent chemicals lodged in a high tortuosity microporous polymeric material.

### BRIEF DESCRIPTION OF THE DRAWINGS

For a fuller understanding of the nature and advantages of the present invention, reference should be had to the following detailed description taken in connection with the accompanying drawings, in which:

FIG. 1 graphically portrays release profiles for RIFA repellents and control agents from microporous carriers (temperature 75° F.), as reported in Example 1;

FIG. 2 graphically portrays data for MP100 pellets load with 2.5-3 grams actives, as reported in Example 1;

FIG. 3 graphically portrays data for MP100 pellets loaded with active ingredient, as reported in Example 1;

FIG. 4 graphically portrays the mean number of live fire ants on a square tray, as reported in Example 4;

FIG. 5 graphically portrays the mean number of live fire ants on a square tray, as reported in Example 4;

FIG. 6 graphically portrays the mean number of live fire ants on a square tray, as reported in Example 4;

FIG. 7 graphically portrays the mean number of foraging ants on a square in 3 hours of field data, as reported in Example 4; and

FIG. 8 graphically portrays the influence of X17 coating on DG 150 granules, as reported in Example 5.

The drawings will be described in further detail below.

### DETAILED DESCRIPTION OF THE INVENTION

There exist a number of technical solutions that can resolve many RIFA problem areas. For home/yard, public areas, and industrial sites or facilities that are know to attract the RIFA, sustained-release delivery systems (“SRDS”), which would either attract or repel RIFA's can be designed to work for periods of about 2 months under harsh conditions on up to about 5 years or more, as needed. In the case of transportation of related quarantines, systems can be designed to both exclude/repel RIFA's, and/or attract and isolate RIFA's, for monitoring and verification purposes.

The following delineates over 5-years of activities to create and validate the performance of these systems.

### (1) Point and Area Protection:

Control of RIFA's in open areas such as, for example, yards, public areas, and/or specific sites where RIFA's present both a human hazard and technical problems with electronic equipment, we have designed polymeric carrier/delivery stems which can function for about 5 to about 20 years.

These systems are composed of a degradable or non-degradable soil stake system or it can be a sprayable polyurethane based delivery system where it can be applied to, for example, transformer platforms and alike. The system can employ either a repellent or an attractant, and insecticidal compound or growth regulator in combination.

We have demonstrated that a number of bioactives can act as effective repellents for the RIFA, when placed into a polymer carrier/delivery system. These include, for example: (a) bifenthrin—a device can repel fire ants from small areas of approximately 200-10,000 ft²; (2) decanol; (c) diethyl adipate; (d) permethrin; and (e) lambdacyhalothrin. Release rates for bifenthrin have been measured at about 1 to about 20 mg/cm²/da for urethanes, about 11 to about 45 for decanol, about 9 to about 34 for diethyl adipate in degradable polymers, and about 20 to about 70 for permethrin in both degradable polymers and urethanes. Release rates can be reduced to the μg/cm²/da by use of specific carriers and releasing matrices which, thus, increase longevity.

The types of carriers, polymers, and bioactives depend on the application, namely release rates required and functional longevities wanted. For degradable polymer systems with longevities of about 1 to about 5 years, we can employ polyox, lactic aid polymers or a combination of both to adjust physical longevity of the device. For longer term control (about 10 to about 20 years), we can employ a range of thermoset urethane products, all employ isocyanates and active hydrogen compounds (e.g., polyols or organonitrogen compounds that form crosslinked structures).

### (2) Quarantine and RIFA Repellency.

Studies have been conducted to protect specific agricultural product types, such as, for example, potted nursery stock containing soils or other potting media. These have shown that a thin polymer membrane or polymer spike containing a range of bioactives can be effective in repelling RIFA; thus, assuring that plants and soils from quarantined areas can be safely shipped. The bioactives used to date include, for example, bifenthrin, lambda cyhalothrin, and diethyl adipate. The polymer types can range from short-term (about 2 to about 4 months) degradable polymer spikes to longer lasting (about 1 to about 5 years) urethane membrane systems. Studies have shown that these system repel RIFA's for at least about 2 years

### (3) Quarantine Monitoring/Validation.

With the expanding range of the RIFA, states and countries with warmer climates and infrequent freezing periods require a level of certainty with regards to the presence and particularly the absence of RIFA's in containerized/transport cargo. An effective monitoring system, which has attributes of RIFA attraction, and trapping, with longevity of about 2 months, is required.

The system that has been developed is a simple system that employs an attractant in the center of a sticky pad. This system serves to attract RIFA, if present in the cargo container, and allows for a visual indication of any RIFA's based on whether or not any RIFA's are entrained in the sticky pad. The attractants, which we have employed, include hemoglobin, stable meat byproducts, and pherome like RIFA attractants. The stick pad is the OEM available adhesive based non-hardening tackifiers.

### (4) Technical Applications to Control Repellency, Attraction, Release Rate and Longevity.

Any number of chemical repellents can be employed. We have used, for example, bifenthrin, decanol, diethyl adipate, permethrin, and lambdacyhalothrin, while available pheromones or pheromone-like compounds also can be used. Attractants we have employed include, for example, soybean and other edible (e.g., trigylyceride) oils, and a mixture of hemoglobin, and glutathione; again available pheromones also can be used.

The functional longevity of the product device can be adjusted by application need by use a range of polymers. For short duration systems (under about 2 years), degradable polymers including polyox and polylactic acid can be used individually or in combination. For extended matrix longevity, the use of thermoset urethanes is preferred. These allow for adjustments in cross-linking and hardness measured with a durometer and composition can be readily adjusted to help control bioactive release rates, and adjust for extremes in environmental behavior at elevated temperatures.

The crucial part of the formulations for the above polymeric systems is the means employed to contain sufficient bioactive component loading, and to control the magnitude of the release rate. This is managed by use of internal carriers for the bioactive component. Depending on the chemical nature of the bioactive component (vapor pressure, solubility in the polymer, diffusion rate through the polymer, and chemical reactivity and or hydrolysis rates), suitable carriers are used to hold and then release the active to the polymer for subsequent release to the environment. The carriers of choice are intercalated nanoclays, specific carbon blacks, and microporous polyethylenes. In all cases the active is sorbed into the carrier, prior to mixing with the polymer, and subsequent manufacture of the devices.

### Pests and Pest Control Agents

The specific pests to be targeted will depend on the climate and many other local factors. The pest control agents that are included in the various embodiments of this invention include, inter alia, herbicides, insecticides, nematicides, and fungicides or other pest control agents such as, for example, chemical attractants and repellants that are effective against the targeted species. The following exemplary target pests indicate the vision of the invention that is to control the most troublesome pests.
Insects controlled in turf and/or pasture settings
   a. Fire ants
   b. Mole crickets
   c. Chinch bugs
   d. Army worms, cut worms, webworms
   e. Grubs of June beetles and other beetles
Insects controlled in home setting
   a. Cockroaches
   b. Ants
   c. Spiders
   d. Silverfish

The following examples show how the disclosed method has been practiced using FIFA as an exemplary target species, but should not be construed as limiting.

### EXAMPLES

### Example 1

### Accurel Microporous Delivery Systems

Membrana (Membrana GmbH Corporation, Federal Republic of Germany) developed processes that make open cell structures in which the cells are interconnected (see, for example, U.S. Pat. No. 6,497,752 for 75% air product). The pores are about 5 microns to 20 microns in diameter. They have very low densities because the products are 50 percent to 90 percent air. They are sold under the trade name Accurel®. They are commercially successful as a means of supplying liquid polymer additives (coloring agents, lubricants, etc.) in a solid form. The pellets can be blended well with polymers prior to extrusion or molding and then are released when the polymer mixture is melted. Accurel products also have been used in pharmaceutical drug delivery systems in which the goal is to release oral drugs in the stomach or small intestine.

It is, therefore, remarkable that these microporous delivery systems that release materials at high temperatures or release them within a few hours could be adapted for use in sustained release systems that operate over months and even years. Conversion of the time scale for pesticide delivery systems is attained by a special pretreatment of microporous materials described herein. A combination of pressure and vacuum treatments is employed that partly destroys the elegant open pore structure (see Example 1). We believe that highly tortuous paths are generated by this rough treatment.

Although these experiments have been done only on Membrana Accurel microporous systems, we believe that they are applicable to Foamex microporous products too.

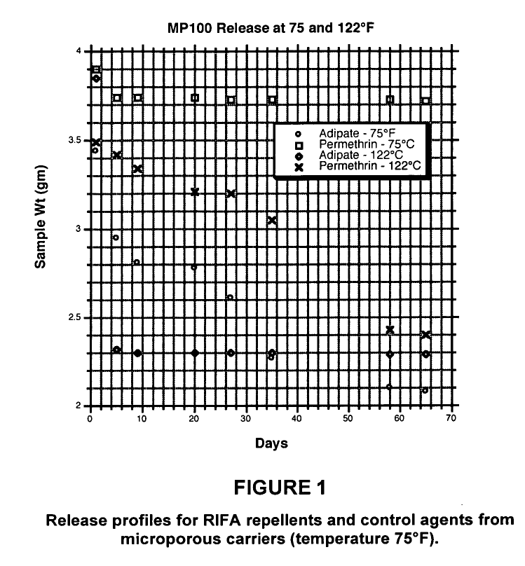

All five chemicals were effective repellents and/or biocides in lab bioassays, as shown in FIG. 1 and Table 1.

TABLE 1
Release Rate And Longevity Of Selected Repellents

| | Release Rate | Longevity |
|---|---|---|
| Control Agent | (mg/day) | (days) |
| Adipate | 112 | >90 |
| Decanol | 114 | >90 |
| Permethrin | 0.68 | >265 |
| Bifenthrin | 0.98 | >265 |
| Tefluthrin | 1.13 | >265 |

The diethyl adipate (Adipate) and Decanol ingredients exhibit classic first order release during the first 100 days. Adipate enters steady state release at around 120 days. Decanol is also heading for steady state at about 150 days. Because there is a significant release soon after the repellent is applied, this is advantageous if there is a fire ant infestation situation.

The three pyrethroids remain at steady state throughout the test time span. In essence, the surface of their product (e.g. a transformer box) contains a repellent with no significant release of the active ingredient into the environment. There is a gradual release that refreshes the surface protection.

An especially useful formulation would comprise an Adipate or Decanol and a pyrethroid. The former gives a quick response and the latter protects for the long term.

### Thermal Aging of MP100 Loaded Pellets at 750 and 122° F.

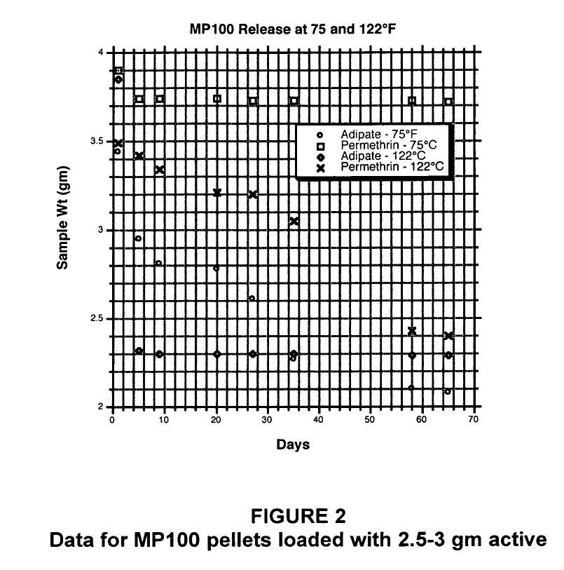

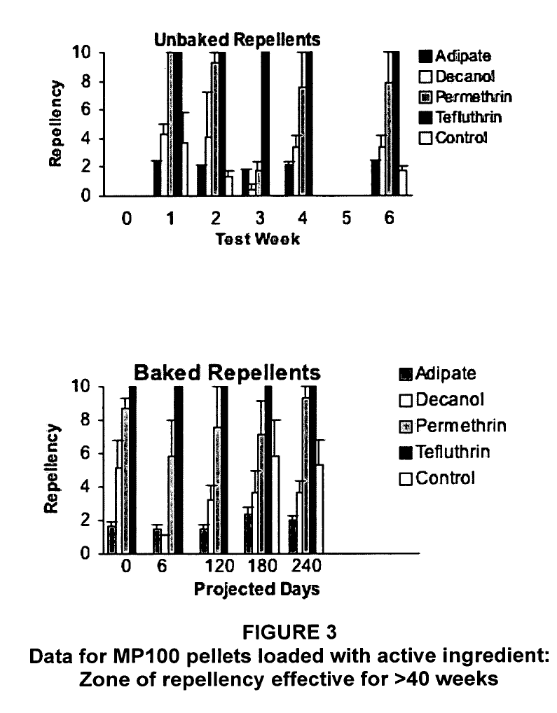

Comparison of release at 75° F. and 122° F. (see FIGS. 2 and 3) provides surprising and useful information concerning release of various chemicals from the microporous delivery system. In 70 days, permethrin exhibits steady state release at 75° F., but follows first-order declining exponential kinetics at 122° F. Adipate, that exhibited first-order declining exponential kinetics at 75° F., shows steady state release at 122° F.

Each of these behaviors is easily explained using the concepts of concentration gradient and Arrhenius physical kinetic theory. At low temperatures, the Arrhenius exponential term is too small to affect Permethrin's behavior. At higher temperatures, the exponent that is a function of temperature causes the curve to become non-linear. For Adipate at the lower temperature, the concentration gradient and temperature causes the first order exponential behavior. At the higher temperature, the release is so rapid that the concentration gradient is reduced to a low value within a few days. A steady state results.

These physical and theoretical results provide information on how to design a successful fire ant control product. This information is not obvious to those with ordinary skill in the pest control art. Fire ants thrive in environments that have wide temperature swings. There are seasonal swings and swings between day and night. Some significant fire ant environments (e.g., electric company transformer boxes) have heat transfer to supplement solar energy inputs. For an effective active ingredient, the release will sometimes be steady-state and sometimes be first-order exponential. In order to determine an optimal warranty, one must take these factors into account. A dynamic simulation model is the best way to do this.

Unbaked repellent pellets were stored at room temperature. (ca. 75° F.). Baked repellent pellets were stored at 122° F. Repellency was measured by the closest distance in centimeters that fire ants will come to a sugar solution bait. They died of starvation rather than come closer.

The two pyrethroids were stronger repellents than the other two candidates. The repellent winner is Tefluthrin, but Permethrin may be better when longevity and cost are taken into account. As shown in FIG. 1, Permethrin's release rate is slower than that of Tefluthrin. Bifenthrin was not included in this test and may be the best of all.

### Example 2

### Cast Urethane Delivery Systems Using Microporous Carrier

The ratio of Vibrathane 6020 isocyanate to 1,4-BD that works best for the candidate repellents was 300 parts to 24 parts, respectively. Approx 50 μl of LV33 catalyst was added per 42.8 grams of above polymer. To this mixture was added, by blending, 13.2 gm of candidate repellent pre-sorbed into 1.8 gm of Accurel® XP 100 microporous polyolefin, or 13.2 gm of neat candidate repellent. They were thinned in both cases with 10% hexane (w/w), to allow easier infiltration into the XP100, and/or aid in mixing with the polymer. This yielded a final candidate repellent content in the polymer of about 21% actives. The mixture was stirred to mix active and then poured into sheets approx ⅛ to 3/16 inch thick.

The mixture could be stirred and poured for a period of approximately 10 minutes after mixing, before thickening and setting of the urethane. Based on prior efforts, the best durometer for repellency ranges from A70 to A90, after approximately 2 days. If the ratios result in too hard a polymer, release rates are too slow to be effective; if the mixture is too soft, polymerization is inhibited and release rates are too fast.

Many thermoset polymers can be used as a matrix for the repellent in delivery systems. Polyurethanes and epoxies are prime examples. Loss of bioactivity can happen when the repellents can react with isocyanates or epoxy groups. Carriers can prevent this problem and can add substantially to the longevity of repellency. We illustrate the use of carriers for this purpose by making and using cast urethanes that contain fire ant repellent chemicals that are stored in carriers.

We prepared repellent sheet samples that contain three commercially-available pyrethroid candidate repellents.

TABLE 2

| Ingredient | Add pph | H | I | J | K | L | M | N |
|---|---|---|---|---|---|---|---|---|
| Vi 6020 (300) | 15 | 40 | 40 | 40 | 40 | 40 | 40 | 40 |
| 1,4-BD (24) | 1.2 | 2.8 | 2.8 | 2.8 | 2.8 | 2.8 | 2.8 | 2.8 |
| Catalyst (1 drop/100 mL) | | 1 | 1 | 1 | 1 | 1 | 1 | 1 |
| Permethrin in XP100 | | 15 | | | | | | |
| Permethrin Neat | | | 13.2 | | | | | |
| Bifenthrin in XP100 | | | | 15 | | | | |
| Bifenthrin Neat | | | | | 13.2 | | | |
| Lambdacyhalo in XP100 | | | | | | 15 | | |
| Lambda neat | | | | | | | 13.2 | |
| Control | | | | | | | | 0 |
| Durometer (12/7) | | A80 | 75 | 85 | 90 | 80 | 80 | 85 |
| Durometer (1/31) | | 70 | 70 | 80 | 90 | 80 | 75 | 85 |

TABLE 3
FIRE ANT MORTALITY DUE TO REPELLENTS AS A FUNCTION OF EXPOSURE TIME

| Treatment | 1 hr mean/sd/se | 3 hr mean/sd/se | 7 hr mean/sd/se | 24 hr mean/sd/se |
|---|---|---|---|---|
| Permethrin in XP100 (H) | 28 ± 20 ± 12 | 31 ± 20 ± 12 | 52 ± 28 ± 16 | 52 ± 28 ± 16 |
| Permethrin neat (I) | 13 ± 6 ± 3 | 22 ± 3 ± 2 | 42 ± 14 ± 8 | 42 ± 14 ± 8 |
| Bifenthrin in XP100 (J) | 67 ± 29 ± 17 | 67 ± 29 ± 17 | 70 ± 26 ± 15 | 100 ± 0 ± 0 |
| Bifenthrin neat (K) | 30 ± 17 ± 10 | 67 ± 42 ± 24 | 68 ± 39 ± 22 | 83 ± 29 ± 17 |
| Lamdacyhalo in XP100 (L) | 90 ± 10 ± 6 | 100 ± 0 ± 0 | 100 ± 0 ± 0 | 100 ± 0 ± 0 |
| Lamdacyhalo neat (M) | 21 ± 12 ± 3 | 21 ± 12 ± 7 | 21 ± 12 ± 7 | 58 ± 38 ± 22 |
| Control (N) | 0 ± 0 ± 0 | 0 ± 0 ± 0 | 0 ± 0 ± 0 | 0 ± 0 ± 0 |

Bailey Parks/Vibrathane 6020 (300) 1,4-BD (24) Catalyst (1 drop/100 mL).
Harder durometer product was used.
The means represent the % of colony death in each of the cells counting from the time the repellents were introduced into the cells containing the ants.

The most powerful candidate is Lambda in XP 100 that achieved 90% kill in the first hour and 100% kill in 3 hours. Bifenthrin in XP100 attained 100% kill within 24 hours and 67% within the first hour. In comparison, Permethrin seemed quite sluggish.

All of the pyrethroids are benefited by use of a carrier, even in short term exposure. The products containing carriers kill more fire ants than those that have neat repellents. Thus, the results of this short-term experiment are remarkable because one would expect the neat repellent to be more abundant on the surface of the polymer than the repellent sorbed in XP100 because most of it is stored in the carrier.

Reactions of the neat repellents with the monomers probably is occurring during the mixing and casting process. These pyrethroids do not have functional groups that react with isocyanates. They are all esters of a substituted cyclopropane carboxylic acid. These esters might be cleaved by the butanediol. Neat Lambda is most adversely affected and Bifenthrin is survives best, Bifenthrin is a primary benzyl alcohol while Lambda has a secondary alcohol attached to an electron-withdrawing group. Permethrin has a secondary benzyl alcohol group. We conclude that the neat form of Bifenthrin is most stable, but probably affected to some degree.

### Example 3

### Nanoclays as Carriers for Fire Ant Repellents

Various clay carriers were evaluated to determine their capacity to adsorb and retain pesticide, and their capacity to thereafter release the pesticide.

### Clays

(1) Attapulgus clay (ATTP)
(2) Montmorillinite (bentonite) clay
(3) Nanoclays from Nanocor, Inc. (onium ion amine modified Montmorillonite products, intended for polymer use)
(a) Nanomer I.30E (70%-75% Montmorillonite; 25%-30% protonated octadecylamine)
(b) Nanomer I.30P (70%-75% Montmorillonite; 25%-30% protonated octadecylamine)
(c) Nanomer I.34TCN (65%-80% Montmorillonite; 20%-35% methyl tallow bis(2-hydroxyethyl) ammonium salt
(d) Nanomer I.44PA (77% Montmorillonite; 23%-30% dimethyl diialkyl [C14-C18] Ammonium salt
(e) Nanomer PGV (Montmorillonite with trade secret additive)

### Typical Mixing Procedure

Bifenthrin is a typical repellent used in this mixing procedure description. It is a solid that melting without decomposition. Bifenthrin was heated to its melting point (ca. 60° C.). A Blakeslee mixer (Model B-20) was adapted to have its interior heated to the desired temperature. The temperature of the clay and added pesticide within the bowl was maintained using heating straps attached to the outside mixing bowl (heaters controlled at 70° C., actual temp of stirred clay pesticide mixture was about 65° C.). The nanoclay was slowly added to the mixer bowl at a rate of 5 mL/min-10 mL/min, with the mixer at a low (1) blending setting (1-quart Waring Blender). Addition of the Bifenthrin was halted when the mixture just started to ball up. Mixing was continued for another hour at a higher mixing setting to break smaller clumps. The mixture then was cooled to room temperature, passed through a #60 sieve (<250 microns); remaining clumps (<10% total weight) were gently ground in a shear blender.

Liquid active ingredients (liquid at room temperature) were treated by the same procedure, except that the materials were not heated and cooled.

These procedures do not use water or organic solvents, as is customary in intercalating and exfoliating clays.

### Holding Capacity

Each tested active agent was slow-blended into the clay or nanoclay using a Blakeslee mixer, as described above. Active agents that were solid at room temperature were pre-melted, the clay heated, and the heated ingredients mixed by the same procedure. The following results were recorded.

TABLE 4

| | HOLDING CAPACITY | | |
|---|---|---|---|
| | Gm active/(gm active ingredient + clay | | |
| Nanocor N | | | |
| I.34TCN | | | |
| 02-87-M | Dimethyl succinate | 0.67 | Good mix; swells |
| 02-87-P | 1-decanol | 0.62 | Good mix; swells |
| 02-87-S | Permethrin | 0.52 | Good mix; swells |
| 02-87-X | Bifenthrin | 0.51 | Good mix; swells |
| 02-87-Z | Trifluralin | 0.39 | Good mix; swells |
| Nanocor N I.44PA | | | |
| 02-87-Z | Trifluralin | 0.37 | Good mix; swells |
| Nanocor N I.30E | | | |
| 02-88-M | Dimethyl succinate | 0.69 | Good mix; swells |
| 02-8-N | Diethyl adipate | 0.27 | Good mix; swells |
| 02-88-P | 1-decanol | 0.27 | Good mix; swells |
| 02-88-S | Permethrin | 0.53 | Good mix; swells |
| 02-88-V | Nonanol | 0.55 | Good mix; swells |
| 02-88-X | Bifenthrin | 0.55 | Good mix; swells |
| 02-88-Z | Trifluralin | 0.46 | Good mix; swells |
| Nanocor N I.30P | | | |
| 02-89-M | Dimethyl succinate | 0.69 | Good mix; swells |
| 02-89-N | Diethyl adipate | 0.51 | Good mix; swells |
| 02-89-P | 1-decanol | 0.61 | Good mix; swells |
| 02-89-S | Permethrin | 0.56 | Good mix; swells |
| 02-89-V | Nonanol | 0.55 | Good mix; swells |
| 02-89-X | Bifenthrin | 0.53 | Good mix; swells |
| 02-89-Z | Trifluralin | 0.42 | Good mix; swells |
| Nanocor PGV | | | |
| 02-90-M | Dimethyl succinate | 0.45 | No visible change |
| 02-90-P | 1-decanol | 0.32 | Good mix; swells |
| 02-90-S | Permethrin | 0.4 | Liquid on surface |
| 02-90-V | Nonanol | 0.46 | Liquid on surface |
| 02-90-X | Bifenthrin | 0.41 | No visible change |

The holding capacity of nanoclays exceeds that of many carriers. However, the microporous materials have almost 7 times as much holding capacity as nanoclays. The best nanoclays can outstrip the microporous materials in providing low release rates. The nanoclays can complex with the polymer matrix, thereby increasing the tortuosity of the path that molecules must follow to reach the surface. This can reduce the advantage of the microporous materials in longevity and increase the value of the nanoclay products.

### Urethane/Nanoclay Delivery Systems.

The following thermosets that contain N I.30E nanoclay loaded with a variety of pesticides were evaluated:

(a) Solithane S113, C113 and TIPA polyurethane (Uniroyal).

(b) Flexane 80 polyurea (ITW Devcon).

(c) Vibrathane 6020 (Crompton)

The pesticide-loaded clay or nanoclay was prepared by the mixing method described above.

Solithane S113 is toluene diisocyanate (the isocyanate component) and C1134 is castor oil (the polyol component). The active ingredient-loaded N I.30E was dispersed into C113 and then blended with Solithane S113. Tripropanolamine (the catalyst) was added. These ingredients are mixed and cast into a mold that formed sheets similar to the ones used to evaluate thermoplastics.

Flexane 80 liquid resin is an aliphatic diisocyanate (dicyclohexylmethane-4,4′-diisocyanate). Its curing agent is diethyl toluene diamine. The ratio of resin to curing agent was 78 to 22. The active ingredient-loaded N I.30E was blended with the curing agent and mixed with the resin. These ingredients are mixed and cast into a mold that formed sheets similar to the ones used to evaluate the thermoplastics.

The results of the release rate study are shown in Table 7. The release rate studies were performed by the flow method. The poor result for decanol in the Solithane series was due to its reactivity with aromatic isocyanates.

The release rates for the urethanes are quite acceptable for most of the intended uses. They are not as low as the release rates from the experiments with thermoplastic polymers; however, both types could be optimized for higher or lower targets to meet target release rates.

TABLE 5
URETHANE RELEASE RATES*

| | | | | RELEASE |
|---|---|---|---|---|
| | | ACTIVE | | RATE |
| SAMPLE | POLYMER | AGENT | MIX/SET | (μG/CM²/DAY) |
| 02-79-M | Solithane/ | Dimethyl | Good | 11 |
| | Urethane | succinate | | |
| | F80 | Dimethyl | Excellent | 22 |
| | Urethane | succinate | | |
| 02-79-N | Solithane/ | Diethyl | Marginal | 14 |
| | Urethane | adipate | | |
| | F80 | Diethyl | Good | 16 |
| | Urethane | adipate | | |
| 02-79-P | Solithane/ | 1-decanol | Poor | 31 |
| | Urethane | | | |
| | F80 | 1-decanol | Good | 28 |
| | Urethane | | | |
| 02-79-V | Solithane/ | 1-Nonanol | Poor | 25 |
| | Urethane | | | |
| | F80 | 1-Nonanol | Good | 19 |
| | Urethane | | | |
| 02-79-S | Solithane/ | Permethrin | Good | 5.7 |
| | Urethane | | | |
| | F80 | Permethrin | Good | 5.9 |
| | Urethane | | | |
| 03-11-X | Solithane/ | Bifentrin | Good | 3.2 |
| | Urethane | | | |
| | F80 | Bifentrin | Good | 4.5 |
| | Urethane | | | |
| 03-11-T | Solithane/ | Cypermethrin | Good | 6.5 |
| | Urethane | | | |
| | F80 | Cypermethrin | Good | 7.9 |
| | Urethane | | | |
| 03-11-U | Solithane/ | Fenvalerate | Good | 6.1 |
| | Urethane | | | |
| | F80 | Fenvalerate | Good | 6.4 |
| | Urethane | | | |

*Release rates measured with wipes of surfaces over 6-month period; active loading was set 10% parts by weight. Release rates mimic vapor pressures, high release:high Vp

### Example 4

### Thermoplastics/Nanoclay Delivery Systems to Control Fire Ants

This example makes use of Bifenthrin. The methods and technical results are typical of what we use in fire ant technology.

Injection molded samples (Table 8) were prepared using a Model 45 MINI-JECTOR (Mini-Jector Machinery Corp., Newbury, Ohio). The mold used produced test sheets that were 7.5×5 cm and 1 mm thick. The polyethylene used was powdered Quantum Microthene (XU594, 35 mesh). The polymer was mixed with the sorbent (clay or nanoclay) to provide a final ratio of 2 parts Bifenthrin to 20 parts polymer (24 gm load for each injection). For the PE, the injector was set up to melt the mixture at 127° C., with the injection nozzle heated to 138° C. Polypropylene was melted and injected at 163° C.

These sheets were washed in 90% MeOH to remove surface contamination and placed into a flow device that exposes the sample to water that contains 0.01% Tween 20 and 0.5% MeOH. The system was operated at room temperature (ca. 23° C.). These conditions are used as an accelerated test in which 24 hours represents two to three years' exposure, once release equilibrium is achieved at each of the three target temperatures.

### Methods

### Repellent Preparation

Bifenthrin was sorbed into a nanoclay (Nanocor I.30P) as described above and combined with poly MDI and Rhino Slow® polyol curing agent. The mixture was applied by pouring, rather than spraying. It cured overnight.

### Laboratory Evaluation.

Treatment and control squares measured approximately 30 cm×30 cm and were variable in width. The squares were evaluated in the laboratory in plastic fire ant rearing trays (14 cm×44 cm×56 cm). One nest cell containing 5,000-15,000 workers, but not the colony queen, was removed from a queen right colony and placed in a corner of the tray. The ants were allowed to settle for approximately 30 minutes, and then one treated or control square was placed in the center of the tray (shiny side up) taking care not to disturb the ants in the cell. Any ants that were in the area where the square was to be placed were brushed aside with an index card before placing the square. Food lures were placed in the center of the square. The lures consisted of two small weigh boats, one containing 3 crickets and the other containing a cotton ball saturated with a 10% sucrose solution. The trays were monitored and the number of ants foraging on the squares was recorded every 5 minutes for 15 minutes, and then at 30 minutes and every hour thereafter for a total of 3 hours. Three replicates of each treatment were evaluated with a unique colony representing each replicate. Two treatments were evaluated: polymeric squares containing 5% bifenthrin; and polymeric squares containing 2.5% bifenthrin. The control consisted of blank polymeric squares.

### Field Evaluation.

Due to fluctuating fire ant populations of at field sites, the squares were moved to 4 different locations during the 102-week evaluation period. All field locations were evaluated for fire ant activity prior to placement of squares. Activity was determined by estimating the number of fire ants (approximately 30 minutes post hot dog placement) at hot dog lures arranged in a grid at the proposed field test location. Both treatment and control squares were randomly assigned to areas at the site where there was significant foraging activity. Additionally, squares were placed at least 4.5 meters from any other square to avoid contamination and confounding results. The grass was removed in the area directly beneath the squares and approximately 1 cm around the perimeter of the squares. To insure the ants had ready access to the square surface, a paper bridge was designed by cutting a file folder into 10 cm wide strips and folding them in half lengthwise. One side of the bridge was placed on the square surface while the other side was placed into the dirt alongside the square. Squares were initially set out at location 1 on Feb. 1, 2006 and evaluated weekly for 5 weeks. Initially, a small weigh boat with a cotton ball saturated with 10% sucrose solution was placed in the middle of the square, along with 3 crickets that were placed directly on the square; however, after low foraging activity was observed at treatment and control squares (weeks 1-3) the protocol was modified in that the original food lures were replaced by a piece of hot dog (Oscar Myer all beef hot dog). Three positive controls consisted of hot dog lures placed directly on the ground. Foraging activity on the squares was evaluated at the same time intervals that were used in the lab tests.

### Results & Discussion

### Laboratory Evaluations

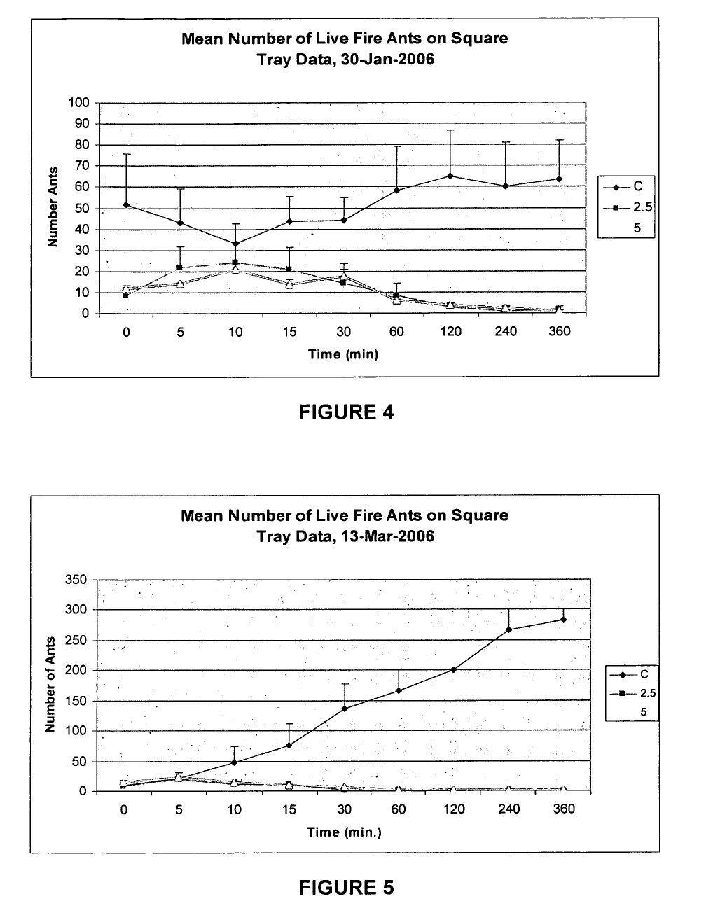

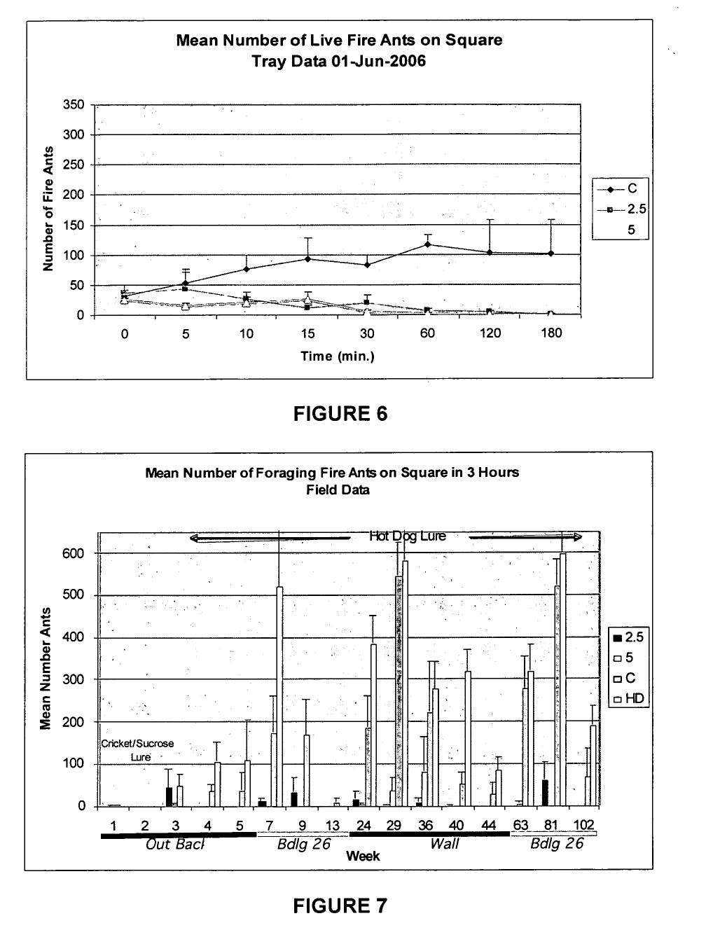

The treatment and control squares were initially tested in the lab in January 2006 (FIG. 4), and were retrieved from their field location and re-evaluated in March and June of 2006 (FIGS. 5 and 6) in order to verify continued efficacy. As can be seen from the FIGS. (4, 5, and 6), after 5 minutes the mean number of ants on the treatment squares was less than the mean number of ants on the control squares. The number of ants on the control generally increased with time, whereas the number of ants on the treatments decreased until there were no ants on the squares. In two of the three laboratory evaluations, the higher bifenthrin concentration gave a quicker reduction of the number of ants on the treatment squares. However, the end result, no ants on the treatment squares, was achieved with both bifenthrin concentrations at the three evaluation periods. The control squares had no apparent effect on the fire ant workers.

These results confirmed in the laboratory that the treatment squares were still active and that the control squares continued to have no effect on the ants. This was important because the lack of ants on the control squares in the field could have been the result control contamination.

### Field Evaluations

FIG. 7 shows the results for the field evaluations. The two-bifenthrin concentrations and the control squares are shown, as well as hotdog lure results where the lures were placed directly on the ground in the field site. This test modality provided a measure of the fire ant population at the field site. By week five, foraging activity at the hotdog lures on the ground was so low at location 1 that the experiment was relocated to a new field site. It is evident from FIG. 4 that the new field site started at week 7 showed a dramatic spike in the number of ants at the hotdog lures. However, by week thirteen the fire ant population at this site also dramatically decreased—not just on the treatment squares—but also in the general area (the ground). A third site was chosen for its high fire ant population, and the treatment and control squares were moved a third time.

Initial evaluations for the control squares and on the ground hotdog lures showed the expected high numbers of fire ant workers. Once again the number of ants at the controls began to decrease. By week 53, the control squares and hotdog lures on the ground no longer drew enough worker ants to have confidence in the results of the treatments. The experiment was moved a forth time back to field site #2, where the fire ant population had recovered in density and could be used again. Evaluations around week 63 and week 81 showed high fire ant worker numbers at the control squares and the hotdog lures on the ground; however, a decline in activity at the control again became evident at week 102, increasing the probability that the experiment will need to be moved again.

The treatment squares invariably had fewer workers than the control squares, and, except for a few instances, the 5% bifenthrin formulation had no detectable fire ant activity after two years of evaluation. Thus, sustained control of fire ant populations for multiple years has been demonstrated. The cyclical decline in fire ant activity after the treatments were put in the field suggests that the treatment formulations are negatively affecting the fire ant population beyond the dimensions of the squares themselves. Additional applications are suggested by these results and observations.

### Example 5

### X17 to Upgrade Anderson Granular Delivery System

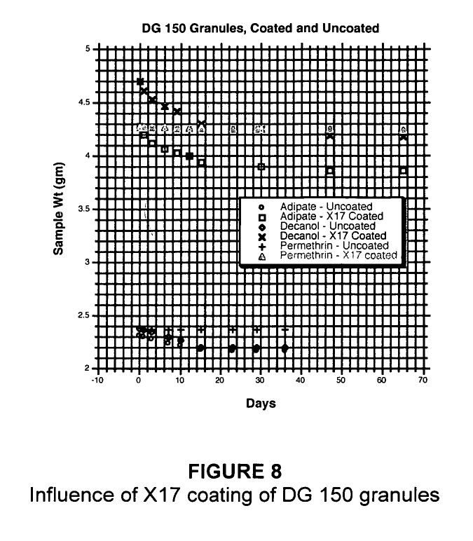

FIG. 8: Influence of X17 coating of DG 150 granules.

TABLE 6
Influence of coating of Anderson DG Lite 150 Granules with X17

| | Release Rate at | |
|---|---|---|
| Sample | Equilibrium (mg/day) | Longevity (days) |
| Adipate uncoated | 2.6 | >65 |
| Adipate coated | 8 | 23 |
| Decanol coated | 3.9 | >65 |
| Decanol uncoated | 10 | 23 |
| Permethrin coated | 0.46 | >65 |
| Permethrin uncoated | 0.46 | >65 |

For decanol and adipate, the X17 coating both reduces release rate and extends longevity; while the coating prevents granule dissolution and rapid release of the active ingredient. With permethrin, release rates are unaffected by the X17 coating, but the device is protected from rapid dissolution during moisture events, thus should extend longevity. The microporous system has a higher active-ingredient capacity than the DG 150 granules, but the X17 method may be more economical in many short-term applications.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

We claim:

1. A method to control insect pests, comprising exposing said insect pests to repellent chemicals lodged in high tortuosity microporous polymeric material wherein said method results in a sustained control of said pests.

2. The method of claim 1, wherein the insect pest is one or more of fire ants, termites, flies, mosquitoes, mole crickets, chinch bugs, army worms, cut worms, web worms, grubs, cockroaches, or silverfish.

3. The method of claim 1, wherein the microporous material has been treated to retain more than 100% of its weight in repellent

4. The method of claim 3, wherein the microporous material is treated with a combination of pressure, vacuum, and heat.

5. The method of claim 1, wherein the repellent chemical is one or more of a pyrethroid, long chain alcohol, or aliphatic ester

6. The method of claim 1, wherein the repellent lodged microporous material is embedded in a polymer matrix

7. The method of claim 6, wherein the matrix is one or more of a polyurethane or polyurea.

8. The method of claim 7, wherein the repellent is a pyrethroid that is stored in an isocyanate component of a 2-part urethane product.

9. The method of claim 1, wherein the high tortuosity arises from constrictions or gas bubbles that block travel to the surface.

10. The method of claim 1, wherein sustained release is at a nearly constant rate.

11. The method of claim 1, wherein release rates are low during winter and high during summer so that the product is most active when the insect pests are most active.

12. A composition of matter comprising a microporous material having at least some pores in the nanometer size range of less than about 1 micron and having trapped gas bubbles.

13. The composition of matter of claim 12, wherein said microporous material is one or more of a polyurethane or a polyurea.

14. The composition of matter of claim 12, wherein said microporous material is treated with a combination of pressure, vacuum, and heat to form said nanometer pores.

15. A method to control fire ants, comprising exposing said insect pest to repellent chemicals lodged in nanoclay materials that also impart high tortuosity to the polymeric matrix.
